(19) United States
(12) Patent Application Publication
(10) Pub. No.: US 2005/0117911 A1
(43) Pub. Date: Jun. 2, 2005

(54) MULTIFUNCTIONAL OPTICAL DEVICE

(76) Inventor: John Hsuan, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,218

(22) Filed: Nov. 27, 2003

(51) Int. Cl. H04L 12/28; H04L 12/56; H04B 10/08; H04B 17/00; H04B 10/00

(52) U.S. Cl. 398/111; 398/19; 370/400

(57) ABSTRACT

A multifunctional optical device includes a switch for switching the multifunctional optical device between a mouse mode, a camera mode, and a scanner mode. An optical sensor array having a plurality of optical sensors is used for capturing images and providing image information. A processor is used for receiving the image information from the optical sensor array and generating processed data. The processor generates the processed data by calculating a location address if the multifunctional optical device is in the mouse mode, processes the captured image if the multifunctional optical device is in the camera mode, and combines a set of linear images if the multifunctional optical device is in the scanner mode. An interface port interfaces the multifunctional optical device with a host computer and outputs the processed data from the processor to the host computer.

### BACKGROUND OF INVENTION

1. Field of the Invention

The present invention relates to a multifunctional optical device, and more specifically, to a combination optical mouse, scanner, camera, and identification recognition device.

2. Description of the Prior Art

Optical mouse devices are well known and have become very popular in recent years. An optical mouse contains a light source for emitting light onto a surface and an optical sensor for detecting movement of the mouse on the surface. Data indicating the position of the mouse along with any mouse clicks is then sent to a host computer.

Another input device available for computers is a handheld optical scanner, which can be used for entering text and images directly into a host computer. Light from the handheld optical scanner is reflected off a document to create an image on an optical sensor such as a charge coupled device (CCD). Data containing the text or image information is then sent to the host computer.

More recently, digital cameras have become a popular tool for taking pictures and transferring the pictures to a host computer. Digital cameras also contain an optical sensor, such as a CCD for capturing photographic images. At a later time, the digital photographs can be transferred to a host computer by connecting the digital camera to the host computer.

As society becomes more concerned with security, optical identification recognition is becoming more popular as a way to verify the identity of authorized persons. To accomplish this, an image-capturing device is usually used to photograph a person and to compare the image of the person with images stored in a database.

Typically, a user must purchase a separate optical mouse, optical scanner, digital camera, and identification recognition device, and connect each device separately to a host computer in order to utilize the features of each device. Besides the expense of buying so many separate devices, the multiple devices lead to physical clutter on a desktop or workstation environment, where space is already at a premium. Moreover, each input device has its own data cable that needs to be connected to the host computer, further cluttering the area surrounding the host computer.

### SUMMARY OF INVENTION

It is therefore a primary objective of the claimed invention to provide a multifunctional optical device for providing input to a host computer in order to solve the abovementioned problems.

According to the claimed invention, a multifunctional optical device includes a switch for switching the multifunctional optical device between a mouse mode, a camera mode, and a scanner mode. An optical sensor array having a plurality of optical sensors is used for capturing images and providing image information. A processor is used for receiving the image information from the optical sensor array and generating processed data. The processor generates the processed data by calculating a location address if the multifunctional optical device is in the mouse mode, processes the captured image if the multifunctional optical device is in the camera mode, and combines a set of linear images if the multifunctional optical device is in the scanner mode. An interface port interfaces the multifunctional optical device with a host computer and outputs the processed data from the processor to the host computer.

It is an advantage of the claimed invention that the multifunctional optical device can perform the functions of an optical mouse, an optical scanner, a digital camera, and an identification recognition device. Integrating all of these functions into the single multifunctional optical devices reduces cost and saves considerable physical space in the crowded desktop area.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a circuit block diagram of a multifunctional optical device according to the present invention.

FIG. 2 is a top view of the multifunctional optical device according to the present invention.

FIG. 3 is a bottom view of the multifunctional optical device according to the present invention.

FIG. 4 is a diagram of the optical sensor array according to the present invention.

FIG. 5 is a diagram of the optical sensor array divided into a plurality of linear blocks of optical sensors.

FIG. 6 is a diagram of the optical sensor array having only one group of optical sensors activated.

### DETAILED DESCRIPTION

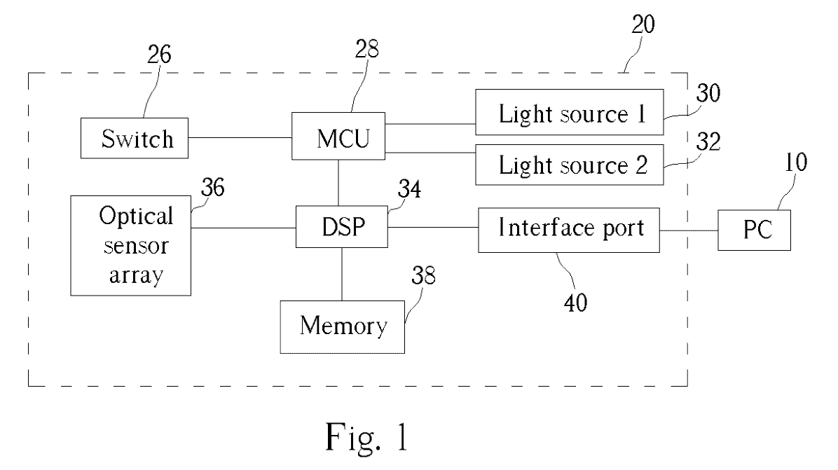

Please refer to FIG. 1. FIG. 1 is a circuit block diagram of a multifunctional optical device 20 according to the present invention. The multifunctional optical device 20 contains a switch 26 for switching the multifunctional optical device 20 between a mouse mode, a camera mode, and a scanner mode. The switch 26 is electrically connected to a microcontroller unit 28, which controls operation of the multifunctional optical device 20. Depending on the mode of the multifunctional optical device 20, the microcontroller unit 28 controls activation of a first light source 30 or a second light source 32. In a preferred embodiment, the first light source 30 emits white light and the second light source 32 emits red light, although other colors of light can also be used. An optical sensor array 36 is used to capture images and provide image information. The optical sensor array 36 is preferably realized with a charge coupled device (CCD) or a complimentary metal oxide semiconductor (CMOS) optical sensor array.

The multifunctional optical device 20 contains a digital signal processor (DSP) 34 for receiving the image information from the optical sensor array 36 and generating processed data according to the mode of the multifunctional optical device 20. The digital signal processor 34 may temporarily store image files in a memory 38 of the multifunctional optical device 20 while capturing images. The memory 38 is preferably non-volatile memory such as flash memory, and may also contain device settings for the multifunctional optical device 20. Finally, the data processed by the digital signal processor 34 is sent to a host computer 10 through an interface port 40. The interface port 40 may communicate with the host computer 10 through a variety of communication protocols, including IEEE 802.11a, IEEE 802.11b, IEEE 802.11g, Bluetooth, USB, PS/2, and IEEE 1394.

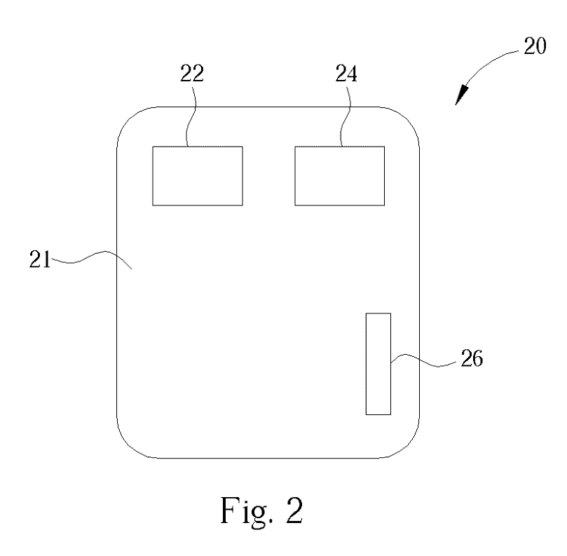

Please refer to FIG. 2. FIG. 2 is a top view of the multifunctional optical device 20 according to the present invention. Mounted on a top surface 21 of the multifunctional optical device 20 is a first button 22 and a second button 24, much like a typical computer mouse. Also formed on the top surface 21 is the switch 26, which is preferably used for changing the mode of the multifunctional optical device 20. Instead of using the switch 26, either one of the buttons 22, 24 or a combination of the buttons 22, 24 can also be used to change the mode of the multifunctional optical device 20.

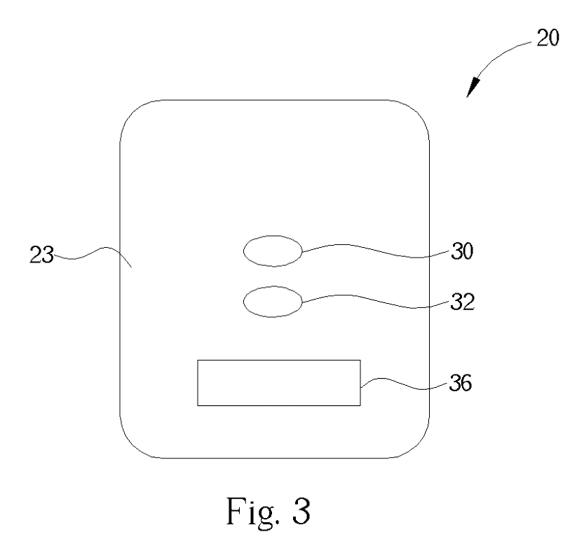

Please refer to FIG. 3. FIG. 3 is a bottom view of the multifunctional optical device 20 according to the present invention. Mounted on a bottom surface 23 of the multifunctional optical device 20 is the first light source 30, the second light source 32, and the optical sensor array 36. As will be explained below, the first light source 30, the second light source 32, and the optical sensor array 36 will be controlled differently in each mode of the multifunctional optical device 20.

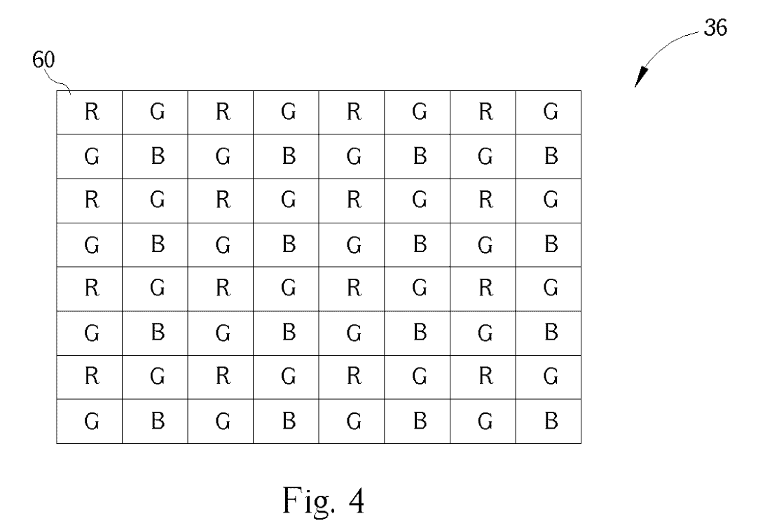

Please refer to FIG. 4. FIG. 4 is a diagram of the optical sensor array 36 according to the present invention. The optical sensor array 36 contains a plurality of optical sensors 60, each optical sensor 60 providing image information for only one color out of a group of at least three colors. Preferably, the optical sensors 60 provide image information for red, blue, and green colors, although other colors may also be used. When the multifunctional optical device 20 is operated in the camera mode, the second light source 32 is turned off. The first light source 30 may be turned on or off, depending on the amount of light required to take a photograph with the multifunctional optical device 20. Each optical sensor 60 in the optical sensor array 36 will be used to capture image information, thereby using the multifunctional optical device 20 like a digital camera.

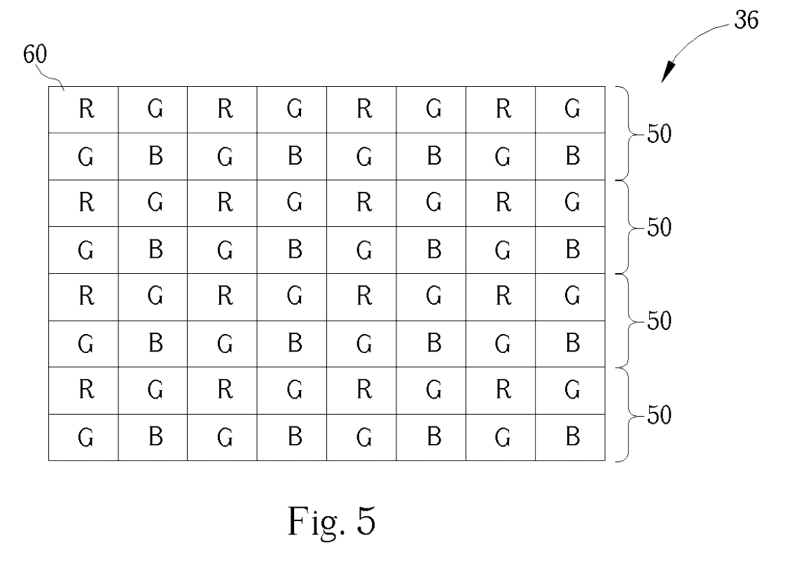

Please refer to FIG. 5. FIG. 5 is a diagram of the optical sensor array 36 divided into a plurality of linear blocks 50 of optical sensors 60. When the multifunctional optical device 20 is operated in the scanner mode, the first light source 30 is turned on to emit white light and the second light source 32 is turned off. The white light emitted from the first light source 30 illuminates a surface, and the optical sensor array 36 is then used to scan the surface. When scanning, successive linear blocks 50 of optical sensors 60 are sequentially activated to capture a set of linear images. The digital signal processor 34 can temporarily store the linear images in the memory 38 before the linear images are transmitted to the host computer 10. Alternatively, the digital signal processor 34 can directly transmit the linear images to the host computer 10 using the interface port 40.

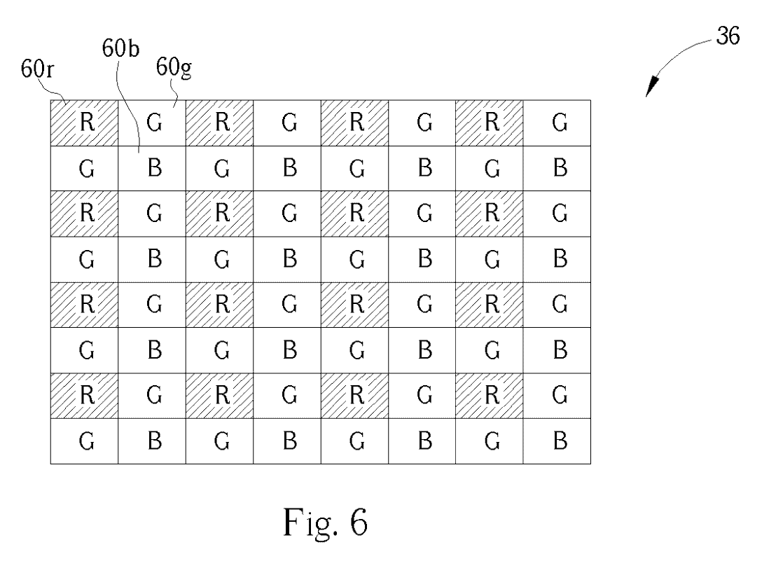

Please refer to FIG. 6. FIG. 6 is a diagram of the optical sensor array 36 having only one group of optical sensors 60 activated. As shown in FIG. 6, the optical sensors 60 are further classified into red sensors 60r, green sensors 60g, and blue sensors 60b, which respectively provide image information for red, green, and blue colors. When the multifunctional optical device 20 is in the mouse mode, the second light source 32 is used to emit red light and the first light source 30 is turned off. In addition, only the red sensors 60r are activated in the optical sensor array 36, which is indicated by the shading in each of the red sensors 60r in FIG. 6. That is, since only the second light source 32 is turned on, emitting a red light on the surface, only the red sensors 60r are needed to detect light reflected from the surface. Based on the movement of the multifunctional optical device 20 with respect to the surface, the digital signal processor 34 is able to compute a location address of the multifunctional optical device 20 and transmits the location address to the host computer 10 through the interface port 40.

In addition to the mouse, camera, and scanner functions, the multifunctional optical device 20 can also provide identification recognition when the multifunctional optical device 20 is in either the camera mode or the scanner mode. To accomplish this, the multifunctional optical device 20 captures image information of a physical feature to enable biometric identification to take place. For example, when the multifunctional optical device 20 operates in the scanner mode, the optical sensor array 36 may scan a fingerprint of a user. The digital signal processor 34 processes the scanned image and sends the processed data to the host computer 10 through the interface port 40. A software program on the host computer 10 then compares the scanned fingerprint data to a database of fingerprints for verifying the identity of the user. Similarly, the multifunctional optical device 20 operating in camera mode can also be used to perform identification recognition. The only difference is a photograph is taken of the user in the camera mode instead of scanning an image, as was done in the scanner mode.

Compared to the prior art, the present invention multifunctional optical device can perform the functions of an optical mouse, an optical scanner, a digital camera, and an identification recognition device. Integrating all of these functions into the single multifunctional optical devices reduces costs and saves considerable physical space in the crowded desktop area.

Those skilled in the art will readily observe that numerous modifications and alterations of the device may be made while retaining the teachings of the invention. Accordingly, the above disclosure should be construed as limited only by the metes and bounds of the appended claims.

1. A multifunctional optical device, comprising:
a switch for switching the multifunctional optical device between a mouse mode, a camera mode, and a scanner mode;
an optical sensor array comprising a plurality of optical sensors for capturing images and providing image information;
a processor for receiving the image information from the optical sensor array and generating processed data, wherein the processor generates the processed data by calculating a location address if the multifunctional optical device is in the mouse mode, processes the captured image if the multifunctional optical device is in the camera mode, and combines a set of linear images if the multifunctional optical device is in the scanner mode; and
an interface port for interfacing the multifunctional optical device with a host computer and for outputting the processed data from the processor to the host computer.

2. The multifunctional optical device of claim 1 wherein each optical sensor in the optical sensor array provides image information for only one color selected from a group of at least three component colors.

3. The multifunctional optical device of claim 2 wherein only optical sensors providing image information for a first color are activated when the multifunction optical device is in the mouse mode.

4. The multifunctional optical device of claim 1 wherein the optical sensor array is logically divided into a plurality of blocks of optical sensors, and when the multifunctional optical device is in the scanner mode, successive blocks of optical sensors are sequentially activated to capture the set of linear images.

5. The multifunctional optical device of claim 1 further comprising a memory for storing device settings of the multifunctional optical device and for temporarily storing images captured by the optical sensor array.

6. The multifunctional optical device of claim 1 further comprising a first light source for illuminating a surface on which the multifunctional optical device is placed with light of a first color when the multifunctional optical device is in the mouse mode.

7. The multifunctional optical device of claim 1 further comprising a second light source for illuminating a surface on which the multifunctional optical device is placed with light of a second color when the multifunctional optical device is in the scanner mode.

8. The multifunctional optical device of claim 1 wherein the processor is a digital signal processor (DSP).

9. The multifunctional optical device of claim 1 wherein the optical sensor array is a charge coupled device (CCD).

10. The multifunctional optical device of claim 1 wherein the optical sensor array is a complimentary metal oxide semiconductor (CMOS) optical sensor array.

11. The multifunctional optical device of claim 1 wherein the interface port interfaces with the host computer through a communication protocol selected from a group consisting of IEEE 802.11a, IEEE 802.11b, IEEE 802.11g, Bluetooth, USB, PS/2, and IEEE 1394.

12. A multifunctional optical device, comprising:
a switch for switching the multifunctional optical device between a mouse mode, a camera mode, and a scanner mode;
an optical sensor array comprising a plurality of optical sensors for capturing images and providing image information, wherein each optical sensor in the optical sensor array provides image information for only one color selected from a group of at least three component colors;
a processor for receiving the image information from the optical sensor array and generating processed data, wherein the processor generates the processed data by calculating a location address if the multifunctional optical device is in the mouse mode, processes the captured image if the multifunctional optical device is in the camera mode, and combines a set of linear images if the multifunctional optical device is in the scanner mode;
a memory for storing device settings of the multifunctional optical device and for temporarily storing images captured by the optical sensor array; and
an interface port for interfacing the multifunctional optical device with a host computer and for outputting the processed data from the processor to the host computer.

13. The multifunctional optical device of claim 12 wherein only optical sensors providing image information for a first color are activated when the multifunction optical device is in the mouse mode.

14. The multifunctional optical device of claim 12 wherein the optical sensor array is logically divided into a plurality of blocks of optical sensors, and when the multifunctional optical device is in the scanner mode, successive blocks of optical sensors are sequentially activated to capture the set of linear images.

15. The multifunctional optical device of claim 12 further comprising a first light source for illuminating a surface on which the multifunctional optical device is placed with light of a first color when the multifunctional optical device is in the mouse mode.

16. The multifunctional optical device of claim 12 further comprising a second light source for illuminating a surface on which the multifunctional optical device is placed with light of a second color when the multifunctional optical device is in the scanner mode.

17. The multifunctional optical device of claim 12 wherein the processor is a digital signal processor (DSP).

18. The multifunctional optical device of claim 12 wherein the optical sensor array is a charge coupled device (CCD).

19. The multifunctional optical device of claim 12 wherein the optical sensor array is a complimentary metal oxide semiconductor (CMOS) optical sensor array.

20. The multifunctional optical device of claim 12 wherein the interface port interfaces with the host computer through a communication protocol selected from a group consisting of IEEE 802.11a, IEEE 802.11b, IEEE 802.11g, Bluetooth, USB, PS/2, and IEEE 1394.
